(19) United States
(12) Patent Application Publication
(10) Pub. No.: US 2009/0210908 A1
(43) Pub. Date: Aug. 20, 2009

(54) PORTABLE COMMUNICATION DEVICE AND ASSOCIATED METHOD FOR SHARING ESG METADATA

(75) Inventor: Anthony J. Sammarco, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/032,071

(22) Filed: Feb. 15, 2008

(51) Int. Cl. G06F 3/00

(52) U.S. Cl. 725/48

(57) ABSTRACT

A portable communication device and method for sharing electronic program information from one mobile device to another device includes an electronic program guide (EPG) application and an EPG sharing application for transparently embedding metadata into communication that may be sent to a recipient via a communications network. The embedded metadata may be used to add the broadcast program to the recipient's EPG. The message or communication may contain a text message, short video message, or other MMS message indicative of the general nature of the program and/or the reasons that the program has been recommended or sent to the recipient.

### TECHNICAL FIELD OF THE INVENTION

The invention relates generally to portable communication devices, such as mobile phones for engaging in voice and/or data communications, and in particular to a method of sharing a broadcast program from one portable communication device to another.

### DESCRIPTION OF THE RELATED ART

Portable communication devices, and in particular mobile telephones, are used for a wide variety of applications. For example, mobile phones are used not only for communicating via phone conversations, but also via text, audio, and video messages, email transmissions, instant messages, etc. Such functionality is well known in the mobile phone art.

Increasingly, mobile phones are also being used to access and view broadcast programming, such as that transmitted by a mobile television provider. Mobile television providers generally provide an electronic program guide (EPG) that allows users to select and view upcoming or scheduled broadcasts. The EPG also allows the user to browse and search broadcast programs by information such as the time of the broadcast or program, the channel, the actors or actresses appearing in the program, the genre, etc. By using the EPG, the user can easily select broadcast programs to view and/or save the broadcast programs for viewing at a later time.

### SUMMARY

To improve portable communication device functionality and use in connection with an electronic program guide (EPG), the present disclosure provides a portable communication device and method for sharing electronic program guide (EPG) information with other users. The portable communication device is equipped to embed EPG metadata into a communication and transmit the communication to a remote device. The remote device may receive the EPG metadata via the communication and add a program to the remote user's EPG in a manner that is relatively transparent to user's of the respective portable communication devices.

One aspect of the disclosed technology relates to a portable communication device that includes an electronic program guide application stored in a memory on the portable communication device, wherein when the electronic program guide application is executed, the electronic program guide application causes the portable communication device to access an electronic program guide including at least one broadcast program available for viewing on the portable communication device and electronic program guide metadata representative of the at least one broadcast program. The portable communication device also includes an electronic program guide sharing application stored in the memory on the portable communication device, wherein when the electronic program guide sharing application is executed, the electronic program guide sharing application causes the portable communication device to embed electronic program guide metadata representative of the at least one broadcast program into a communication for transmission to a remote device.

According to another aspect, the electronic program guide application is operable to receive input from a user to initiate the electronic program guide sharing application.

According to another aspect, the electronic program guide application is operable to prompt a user to share a broadcast program.

According to another aspect, the portable communication device further includes messaging application operable to send communications having embedded electronic program guide metadata to the remote device and receive communications from the remote device.

According to another aspect, the communication includes at least one of a SMS message, MMS message, and/or a text, audio or video message containing user input.

According to another aspect, the electronic program guide sharing application causes the portable communication device to retrieve embedded electronic program guide metadata from the communication transmitted by the remote device.

According to another aspect, the electronic program guide application causes the portable communication device to fetch the broadcast program represented by the embedded electronic program guide metadata.

According to another aspect, the electronic program guide application causes the portable communication device to add electronic program guide information to the electronic program guide based on the electronic program guide metadata embedded in the received communication.

According to another aspect, the communication further comprises text, video and/or audio content.

Another aspect of the disclosed technology relates to a method of sharing program guide information implemented with a portable communication device. The method includes receiving electronic program guide information, the electronic program guide information being representative of at least one program available for viewing on the portable communication device and electronic program guide metadata representative of the at least one program; embedding the electronic program guide metadata into a communication; and transmitting the communication to a remote device.

According to another aspect, the method includes prompting a user to share the at least one broadcast program with a third party.

According to another aspect, the method includes receiving user input indicative of a desire to share a program.

According to another aspect, the communication comprises text, video and/or audio input from a user.

Another aspect of the disclosed technology relates to a method of sharing program guide information implemented with a portable communication device. The method includes receiving a communication from a remote device, the communication including embedded electronic program guide metadata representative of a broadcast program; accessing the embedded electronic program guide metadata in the communication; adding the broadcast program to an electronic program guide associated with the portable communication device via the embedded electronic program guide metadata.

According to another aspect, the method includes prompting a user to accept or reject the embedded metadata.

According to another aspect, the communication includes a text message, SMS message, MMS message, or email transmission.

According to another aspect, the communication includes textual, video and/or audio input from another user.

According to another aspect, the method includes fetching a broadcast program represented by the embedded electronic program guide metadata.

According to another aspect, the method includes transmitting a return message to the remote device, wherein the return message includes comments about the broadcast program and/or acceptance or denial of the broadcast program in the electronic program guide.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a diagrammatic illustration of a communications system including a portable communication device on which aspects of the technology may be carried out;

FIG. 2 is a front view of a mobile phone as an exemplary portable communication device on which aspects of the invention may be carried out;

FIG. 3 is a block diagram of the exemplary portable communication device of FIG. 2;

FIG. 4 is a flow chart or functional diagram representing a method of sharing EPG metadata on the exemplary portable communication device of FIG. 2; and

FIG. 5 is a flow chart or functional diagram representing a method of receiving shared EPG metadata on the exemplary portable communication device of FIG. 2.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As referred to herein, the term “portable communication device” includes portable radio communication equipment. The term “portable radio communication equipment”, which hereinafter is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, and in particular a “mobile device” or a “mobile phone” it will be appreciated that the invention is not intended to be limited to portable communication devices, and can be applied to any type of handheld mobile electronic equipment equipped with EPG functionality and/or EPG sharing functionality.

As used herein, the term “broadcast program” or “program” includes, without limitation, broadcasts, unicasts, multicasts, mobile television programs, mobile TV, other media content programs such as audio broadcasts or podcasts, and the like, etc. The use of one of the forgoing terms in the present disclosure is not intended to exclude others or other similar transmissions or broadcasts.

Portable communication device users may wish to share or recommend a particular broadcast program with another user or friend. To do so, however, the user might have to download and save the particular program, and then attach and send the file as an attachment to a message. Due to the large size of most broadcast files, this is often difficult or impossible to do. Alternatively, the user may manually enter a description of the program and send it to the other user, who, in turn must manually enter the data to search for the program in the EPG. Such a method is also difficult, time consuming, and generally cumbersome to use.

To overcome the difficulties of sharing broadcast programs, the present disclosure describes a method of transparently embedding metadata for fetching or otherwise accessing a broadcast program into a communication or message that may be sent to another user. The user may add a message, for example, a text message, short video message, or other MMS message, indicative of the general nature of the program and/or the reasons that the program has been recommended or sent to the recipient. The recipient may choose to accept the recommendation, and the embedded metadata can then be accessed by the recipient's mobile phone. The recipient's mobile phone may be used to locate and fetch the recommended program for immediate viewing, or to add the broadcast program to the recipient's EPG. Depending on the nature of the recommended program, it also can be scheduled for a later broadcast, downloaded via carousel, fetched immediately via unicast, etc.

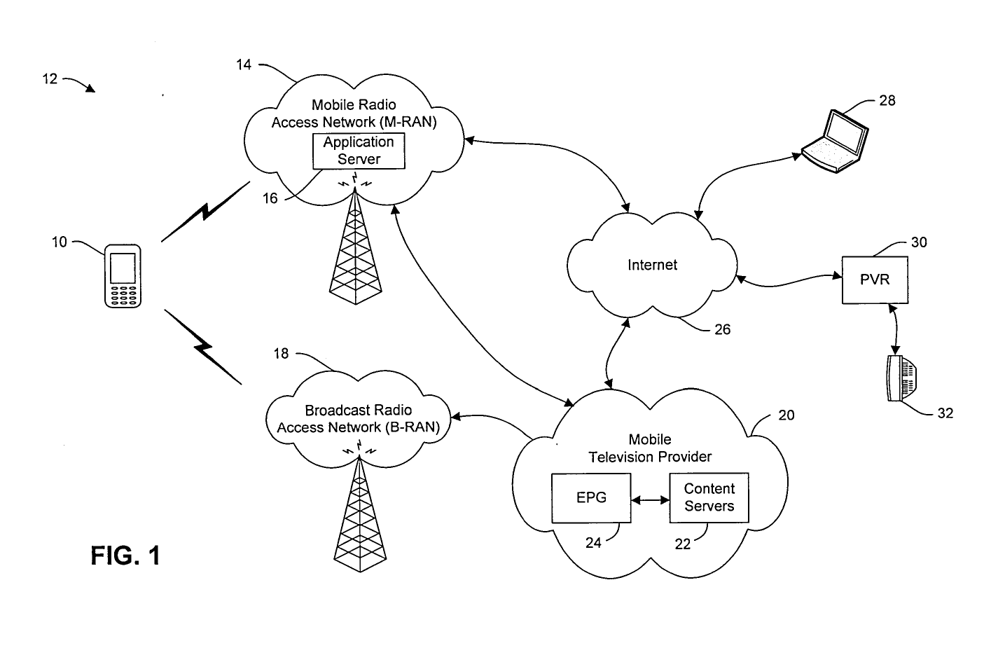

Referring initially to FIG. 1, a mobile phone 10 is configured to operate as part of a communication system 12. The communication system 12 includes a mobile radio access network (M-RAN) 14, such as a mobile cellular telephony network, that facilitates communication, such as voice communication and/or data transfer between a plurality of portable communication devices 10, such as mobile phones, mobile terminals or the like. The mobile network 14 includes one or more servers (referred to generally as application servers 16) for managing calls placed by and destined to the portable communication device 10, as well as supporting one or more applications (e.g., messaging applications).

The communication system 12 also includes a broadcast radio network (B-RAN) 18. The B-RAN is operable to transmit broadcast programs, for example, mobile television programs and the like, between a mobile television provider 20 and the mobile device 10. The broadcast programs transmitted over the B-RAN may originate from the mobile television provider 20 or may originate from a third party broadcaster, such as, for example, CNN, HBO, ESPN, etc. The mobile television provider 20 also may include a server 22 or multiple servers for hosting and managing the programs and content, including those broadcasts that originate from third party broadcasters.

The mobile television provider 20 includes an electronic program information guide, such as, for example, an electronic program guide (EPG) 24, an electronic service guide (ESG) or an interactive program guide (ISG), etc. For simplicity, the electronic program information guide will be referred to as an EPG, however, it will be appreciated that such reference includes all of the aforementioned and similar program information guides and program information guide data.

The EPG 24 is a guide to scheduled broadcast programs (e.g., mobile television programs). The EPG 24 typically includes a graphical user interface (GUI) that is displayed on a screen of the mobile phone to allow the user to view program scheduling and to select programs that may be of interest. By using navigation keys on the mobile device 10, users can navigate the EPG 24, search, and select programs or content stored on the content servers 22 by information such as time, title, channel, actor/actress, genre, etc. The EPG 24 may be programmed to display or recommend content for viewing based upon specified criteria or by learning the user's preferences, for example, based upon other content that the user rates highly, views frequently or that have been recommended by others.

It will be appreciated that the mobile television provider 20 also may be communicable with the M-RAN 14 to send data directly from the mobile television provider 20 to the mobile phone 10. Alternatively, the mobile television provider 20 may be configured to send data to the mobile phone 10 indirectly, for example, via the internet 26, which also may be communicable with the M-RAN 14 and the mobile phone 10. Additionally, broadcast programming from the mobile television provider 20 may be sent to a computer 28, such as, for example a laptop or a media center/CPU or to a personal video recorder (PVR) 30 and television 32, either of which may include a storage means for storing the broadcast program. Alternatively, a broadcast program may be stored on a home network in data communications with the computer 28, the PVR 30 and/or the television 32.

The broadcast programs may be delivered via a two-way cellular network for example, the M-RAN 14, or a one-way dedicated broadcast network, the B-RAN 18. As will be appreciated by one of skill, exemplary broadcast signals include Digital Video Broadcasting Handheld (DVB-H), digital multimedia broadcasting (DMB), TDtv, 1 seg, DAB and MediaFLO, etc. The B-RAN also may include a transmitter to transmit the broadcast signals, as will be appreciated by one of skill in the art.

It will be appreciated that the mobile network 14 includes a network infrastructure, portions of which are used or otherwise accessed by the portable communication devices 10. The portable communication devices 10 may interact with each other and/or the network infrastructure in accordance with any suitable communication standard, including, but not limited to, Advanced Mobile Phone Service (AMPS), Digital Advanced Mobile Phone Service (D-AMPS), General Packet Radio Service (GPRS), Universal Mobile Telecommunications System (UMTS), Global System for Mobile Communications (GSM), Code Division Multiple Access (CDMA), Worldwide Interoperability for Microwave Access (WiMax), Voice-Over IP (VoIP), Session Initiated Protocol (SIP), Wireless Local Area Network (WLAN) or the like. In other words, the communication system 12 shown in FIG. 1 is provided for purposes of explaining aspects of the present invention, without limiting the invention to a particular communication system design, architecture or communication standard. Further aspects of the invention may be employed in connection with device-to-device exchanges (wired, wireless or via intermediary).

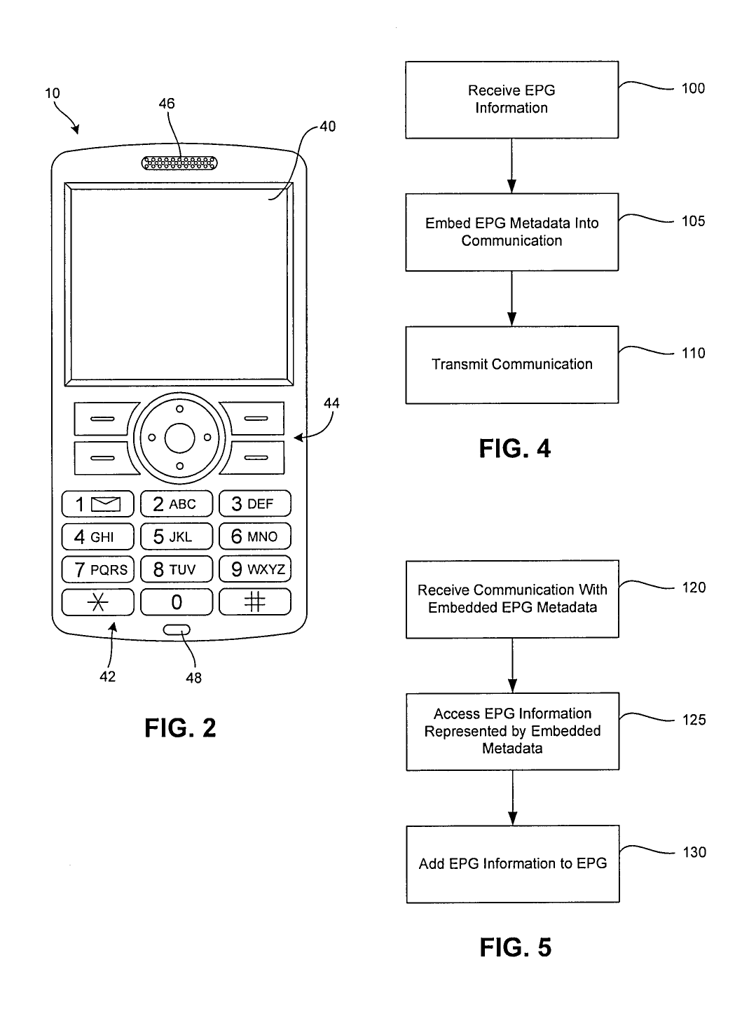

Turning now to FIG. 2, a portable communication device 10 is shown, and in the exemplary embodiment described herein, the portable communication device is a mobile phone 10, but it will be appreciated that the present invention is applicable to other portable communication devices as well. The mobile phone 10 is shown as having a “block” or “candy bar” type of housing, but it will be appreciated that other form factor or housing types, such as, for example, a clamshell or slide-type housings may be utilized without departing from the scope of the present invention.

In the illustrated embodiment, the mobile phone 10 includes a display 40, which may be a touch screen or a touch display, a keypad 42 (e.g., a standard keypad, or a QWERTY keyboard, or a touch screen keypad), one or more functional keys 44, e.g., a guide ball, roller ball, joystick or rocker key, etc., a speaker 46 and a microphone 48. The alphanumeric keypad 42 and the functional keys 44, facilitate the control and operation of the mobile phone 10 by allowing for entry of alphanumeric information, such as telephone numbers, phone lists, contact information, notes and the like. The functional keys 44 typically facilitate navigation through various user menus, such as menus associated with an EPG, and also facilitate utilizing various functions on the mobile phone, including initiating and conducting phone calls, composing and sending messages or other communications. The functional keys and keyboard also may be used to navigate the EPG, and to search for broadcast programs according to specified criteria and/or search terms.

Information, such as recorded digital media, e.g., recorded photos and videos, operating state, time, phone numbers, contact information and various navigational menus, is displayed to the user on a screen or display 40. The display 40 also enables the user to utilize the various features of the mobile phone 10. In addition, the display 40 may be configured to receive user input via detection of user touch of the display, e.g., a touch by finger or by stylus. The display 40 also is used to view the EPG and the broadcast programs from the mobile television provider 20. Alternatively, the display may be external in an embodiment where the mobile phone is a PC card or functioning as a modem to an EPG sharing application (discussed below) on a personal computer.

Artisans will appreciate that the mobile phone 10 further includes suitable circuitry and software for performing various functionality. The circuitry and software of the mobile phone 10 is coupled with input devices, such as the alphanumeric keypad 42, the functional keys 44 and the microphone 48, as well as to the input/output devices, including the display 40 and the speaker 46. It will be appreciated that the display 40 may have any suitable size, shape and positioning without departing from the scope of the present invention. Also, while the exemplary mobile phone 10 is described as having a keypad 42, functional keys 44, and a display 40, it will be appreciated that the mobile phone may include only the display 40 as the primary means for receiving alphanumeric user input and/or navigation commands.

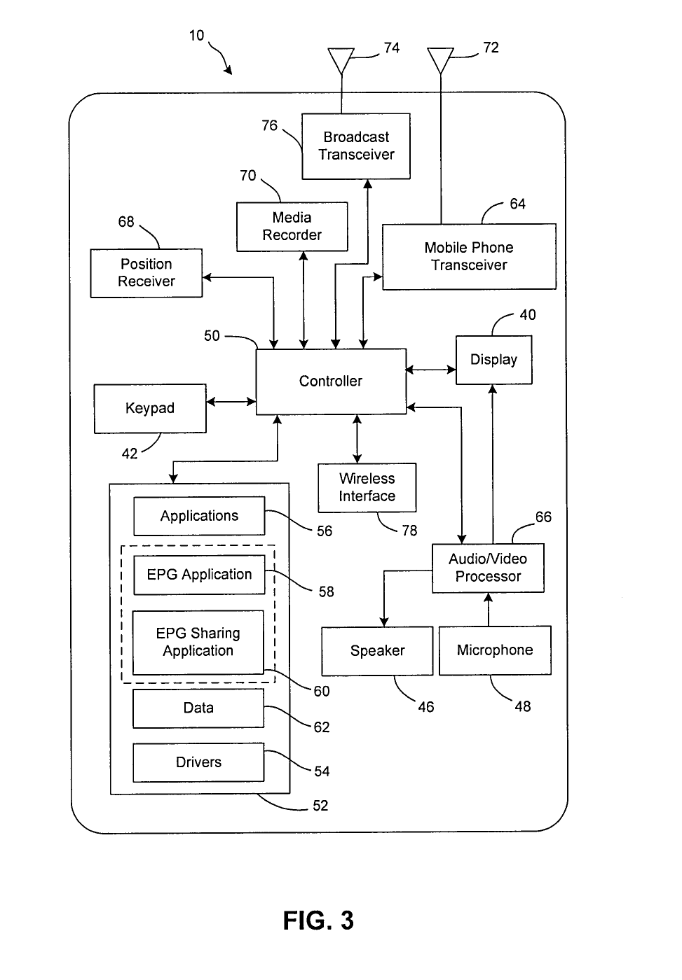

FIG. 3 represents a functional block diagram of the mobile phone 10. The mobile phone 10 includes a controller 50 that controls the overall operation of the device. The controller 50 may include any commercially available or custom microprocessor or microcontroller. Memory 52 is operatively connected to the controller 50 for storing control programs, application programs, and data used by the mobile phone 10. The memory 52 is representative of the overall hierarchy of memory devices containing software and data used to implement the functionality of the mobile phone 10 in accordance with one or more aspects described herein. The memory 52 may include, for example, RAM or other volatile solid-state memory, flash or other non-volatile solid-state memory, a magnetic storage medium such as a hard disk drive, a removable storage media, or other suitable storage means. In addition to handling voice communications, the mobile phone 10 may be configured to transmit, receive and process data, such as web data communicated to and from a web server, text messages (also known as short message service or SMS), electronic mail messages, multimedia messages (also known as MMS), image files, video files, audio files, ring tones, streaming audio, streaming video, data feeds (e.g., podcasts), broadcast programs, and so forth.

In the illustrated embodiment, memory 52 stores drivers 54 (e.g., I/O device drivers), application programs 56, an EPG application 58, an EPG sharing application 60, and application program data 62 (e.g., personality profiles created and/or received by the portable communication device). The I/O device drivers include software routines that are accessed through the controller 50 (or by an operating system (not shown) stored in memory 52), by the application programs, including the EPG application 58 and the EPG sharing application 60, to communicate with devices such as the display 40, keypad 42, and functional keys 44, as well as other input/output ports. The display 40 is operatively coupled to and controlled by a display controller 44 (e.g., a suitable microcontroller or microprocessor).

The application programs comprise programs that implement various features of the portable communication device 10, such as voice calls, e-mail, Internet access, multimedia messaging, contact manager, an EPG application, an EPG sharing application, and the like. As is described more fully below, the EPG application 58 comprises a program, logic routine or code to display the EPG on the screen 40. Also described more fully below, the EPG sharing program 60 comprises a program, logic routine or code to embed metadata for selected broadcast programs into a communication or message that can be sent to another mobile device. The EPG sharing program also is capable of receiving a communication or message from a mobile device that has embedded broadcast program metadata that can be accessed and used to fetch or otherwise access the broadcast program and add the program to the EPG associated with the receiving mobile device.

A person having ordinary skill in the art of computer programming, and specifically in applications programming for mobile phones, will consider it obvious in view of the provided description how to program a mobile phone to operate and carry out the functions described herein, and in particular the functions with respect to the EPG application 58 and the EPG sharing application 60 (and any interfacing between the EPG application 58 or the EPG sharing program 60 and other application programs (e.g., messaging application programs, such as email, text, video, SMS, or MMS messaging, a universal messenger program, media application programs, programs for transmitting packet data or circuit switched data, and the like). Accordingly, details as to the specific programming code have been left out. Also, while the EPG and EPG sharing functionality may be carried out via the controller 50, (alone or in conjunction with other application programs) in the memory 52, such functionality also could be carried out via dedicated hardware, firmware, software or combinations thereof without departing from the scope of the present invention. While EPG application 58 and EPG sharing application 60 are shown and separate application programs, it will be appreciated that their respective functionalities may be embodied in a single or common application program.

With continued reference to FIG. 3, the controller 50 interfaces with the aforementioned display 40 and keypad 42 (and any other user interface device(s)), a mobile phone transmitter/receiver 64 (often referred to as a transceiver), audio and video processing circuitry, such as an audio/video processor 66, and a position determination element or position receiver 68, such as a global positioning system (GPS) receiver. The mobile phone 10 may include a media recorder 70 (e.g., a still camera, a video camera, an audio recorder or the like) that captures digital pictures, audio and/or video. Image, audio and/or video files corresponding to the pictures, songs and/or video may be stored in memory 52 (e.g., in the case of music or video files, in a local media content database).

An antenna 72 is coupled to the mobile phone transceiver 64 such that the mobile phone transceiver 64 transmits and receives signals via the antenna 72, as is conventional. The audio/video processor 66 processes the audio signals transmitted by and received from the mobile phone transceiver 64. Coupled to the audio/video processor 66 are the display 40, the speaker 46 and the microphone 48, which enable the user to listen and speak via the mobile phone 10. Audio data may be passed to the audio/video processor 66 for playback to the user. The audio data may include, for example, audio data from an audio file stored in the memory 52 and retrieved by the controller 50 or audio data associated with a generated or received media-enhanced text message. The audio/video processor 66 also may include any appropriate buffers, decoders, amplifiers and the like.

The mobile phone 10 includes a broadcast antenna 74, which is coupled to a broadcast transceiver 76. The mobile phone 10 sends and receives audio/visual content, such as, for example, broadcast programs received from the mobile television provider 20, via the broadcast transceiver 76 and the broadcast antenna 74. The audio/visual processor 66 is coupled to the display 40 and the speaker 46 to enable the user to view video on the display 40 and listen to audio with the speaker 46. It will be appreciated that the audio/visual content may be stored in the memory 52 and retrieved by the controller 50, and that the audio/video processor 66 may include any appropriate buffers, decoders, amplifiers and the like.

The mobile phone 10 also may include one or more local wireless interfaces (indicated generally as wireless interface 78), such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the mobile phone 10 to the adapter, another mobile radio terminal, a computer, or any other electronic device. Also, wireless interface 78 may be representative of an interface suitable for communication within a cellular network or other wireless wide-area network (WWAN).

Among other variations of the portable communication device 10, it will be appreciated by those of skill in the art that the mobile phone antenna 72 and broadcast antenna 74 need not be separate from one another. Rather, the mobile phone antenna 72 and broadcast antenna 74 may be combined in a single, multi-use antenna capable of receiving both broadcast signals and mobile phone communications. Similarly, the mobile phone transceiver 64 and broadcast transceiver 76 may be combined as a single, multi-use transceiver. It also will be appreciated that the configuration of portable communication device 10 of FIG. 3 is but one possible configuration of a mobile telephone 10 and other, alternative configurations, may be utilized without departing from the scope of the present invention.

While for purposes of simplicity of explanation, the flow charts or functional diagrams in FIGS. 4-5 include a series of steps or functional blocks that represent one or more aspects of the relevant operation of the mobile phone 10. It is to be understood and appreciated that aspects of the invention described herein are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the invention. Furthermore, additional steps or functional blocks representative of aspects of relevant operation may be added without departing from the scope of the present invention.

The methodologies illustrated in FIGS. 4 and 5, which may be implemented on or through the mobile phone 10, relate to methods of sharing EPG data with another device, such as, for example, a mobile phone, a PVR, a computer, and the like. Referring to FIG. 4, the mobile phone 10 is used to view the EPG from the mobile television provider 20. As described above, the EPG contains information about scheduled broadcast programs. The information may be displayed as a navigable menu or table on the display 40 of the mobile phone 10, and the user may select programs available for immediate viewing (e.g., a unicast) or the user may select programs for future viewing or downloading, etc. The user also may select and store programs on the memory of the mobile phone 10 or for storing remote from the mobile phone and later access via the M-RAN, B-RAN, or the internet.

As shown in functional block 100, the mobile phone 10 receives EPG information related to the broadcast programs available (also known simply as EPG data) for viewing and/or download into the memory of the mobile phone. The EPG information can be received from the EPG 24 through the broadcast antenna 74 and broadcast transceiver 76, or a combined mobile phone/broadcast antenna as described above, or in another manner as will be appreciated. The EPG information is sent to the EPG application 58 via the controller 50 where it is processed by the EPG application 58. The EPG application 58 renders the information viewable on the display 40 through the GUI of the EPG application 58. As will be appreciated, the EPG application 58 includes any necessary code for formatting or manipulating the EPG information received from the EPG 24, as may be necessary for viewing the information on the display.

By navigating the GUI associated with the EPG, the user can search and select programs to watch, select and/or recommend broadcast programs to other users. For example, a user may select a “share” or “recommend” function from a menu in the EPG application 58 to implement the functionality of the EPG sharing application 60 and send the metadata for fetching the selected broadcast program to another device by embedding the EPG metadata (or other suitable EPG data) into a communication as shown in functional block 105. For example, the metadata can be embedded into an email, text message, SMS, MMS, or video message, etc.

The EPG metadata (or other suitable EPG data) representative of a given broadcast program may be embedded within or otherwise associated with the communication or message in a way that is transparent or relatively transparent to the device user. For example, the EPG metadata may be embedded within or otherwise associated with the communication or message such that it is not directly viewable by way of with the EPG application 58 or the messaging application. The EPG metadata may, for example, be hidden in a hyperlink attached to or included in the message, or may be embedded as part of the title of the broadcast program or a in short description of the broadcast program, and such information may be provided by the EPG 24.

In one embodiment, the EPG sharing application 60 includes an option for adding personalized content to the communication, such as, for example, a text message, audio message, or video message. The message may be used to indicate the reasons that the program is being recommended (e.g., the program may contain an actor/actress that another user prefers, or may contain subject matter that is of particular interest to another person, etc.). The communication also may include a short description of the broadcast program, for example, as may be received from the EPG, and/or information such as the title of the broadcast program and/or a thumbnail, the time of the next scheduled broadcast, or other descriptive information.

It will be appreciated that while the user may decide to explain or commentate on the recommended broadcast program, such information is not necessary and the metadata for fetching or otherwise accessing a given broadcast program via the EPG may be sent without such optional information. For example, the communication may only contain the embedded EPG metadata, and/or a short description of the program received from the EPG, and the recipient may review this information in determining whether to add the broadcast program to the recipient's EPG. As described in more detail below, once the communication and metadata are received, the recipient can be automatically prompted to accept or reject the given broadcast program (and the EPG metadata or other EPG data associated with or representative of the given broadcast program). In other words, the recipient is prompted to determine whether to accept or reject the recommended broadcast program. This functionality can be accomplished in a number of ways, including, but not limited to as part of the programming for the messaging program and/or the EPG sharing program.

As shown in functional block 110, the user transmits or sends the communication, with the embedded EPG metadata, to the recipient via the M-RAN 14, or via any other suitable mechanism for sending messages, such as text, video or picture messages to a recipient over a mobile network. Other methods of sending the communication will be apparent to one of skill in the art upon review of this detailed description, and such methods are contemplated as being part of this disclosure.

Turning now to FIG. 5, another embodiment of a method of sharing EPG data (and ultimately fetching or otherwise accessing a broadcast program based on shared EPG data) is shown in more detail. A communication containing embedded EPG metadata (or other EPG data) for fetching or otherwise accessing a broadcast program represented by the EPG data is received by the mobile phone 10 as shown in functional block 120. The transmission and receipt of SMS, MMS, text and video messages, etc., types of communications is well known in the art and as such, will not be described in further detail. The mobile phone may be programmed to display an audible or visual indicator to notify the recipient that a new communication or message has been received. The recipient of the communication may open and view the contents of the message on the display 40 as is also well known in the art.

As described above, the communication includes EPG metadata associated with or otherwise representative of a broadcast program and also may include a text, audio or video message explaining the recommendation or the content of the recommended program. Upon receipt of the communication, the recipient can view the text and/or video message and determine whether or not to add the program to the recipient's EPG application via the EPG application 58 and the EPG sharing application 60.

After reviewing the contents of the communication, the recipient can determine whether or not to access the embedded EPG metadata (or other EPG data associated with the communication) to add the broadcast program to the recipient's EPG. The communication may contain a hyperlink, soft key or button or other functionality for prompting the recipient to indicate whether or not to proceed with accessing the embedded EPG metadata to add the EPG information to the recipient's EPG. For example, the communication may include a hyperlink that is selectable by the recipient if the recipient determines that the broadcast program is of interest. Alternatively, the GUI of the EPG application may contain or provide a menu option or selection that the recipient may select to access the metadata.

If the broadcast program is not of interest or the recipient does not want to make a decision on whether or not to add the program to the EPG, the recipient can delete the message, ignore the message, or exit the messaging program without accessing the embedded EPG metadata. The recipient also can save or store the message in the memory for later review or to make a determination of whether to add the broadcast program to the EOG at a later time. Optionally, the EPG sharing application may send a message back to the originator with comments about the recommendation, acceptance/denial status of the recommendation, etc.

If the broadcast program is of interest, the recipient can opt to access the embedded EPG metadata, as shown in functional block 125. The EPG application 58 or EPG sharing application 60 accesses the embedded metadata via an appropriate reader or decoder, as will be appreciated in the art. Once the embedded EPG metadata is accessed, the broadcast program or other EPG information represented by the EPG metadata can be added to the recipient's EPG upon receipt of an appropriate command to add the broadcast program represented by the EPG metadata, as shown in functional block 130. For example, the embedded EPG metadata may be automatically added to the recipient's EPG such that the next time that the recipient initiates the EPG application 58, the recommended program is displayed as part of the GUI. The program also may be automatically fetched and/or added to an EPG “get list” or “requested programs” list, which may, for example, include a queue or list of programs that may not be immediately available or may not be scheduled for immediate broadcast.

Upon broadcast, those programs may be automatically downloaded or saved to the memory of the mobile phone or added to the recipient's EPG. The embedded metadata also may cause the mobile phone 10 to open the EPG application and automatically search for and show all instances or future broadcast programs of the type recommended by the user and also allow the recipient to select which instances or scheduled programs that the recipient would like to view.

It will be appreciated that the EPG sharing functionality described above provides a portable communication device that allows user greater functionality in sharing the power of an EPG with friends. As is described above, the EPG sharing functionality can be carried out in a manner that is relatively transparent to the device user due to the embedding of EPG metadata into a message or other communication. While aspects of the disclosed technology are described in connection with directly embedding EPG metadata (or other EPG data) into a communication, it will be appreciated that other types of messages may be sent. For example, a message may be sent that contains a link to the sender's list of recommended programs stored on a remote server. Activation of the link within the message may allow the recipient to see the sender's program interests and add some or all of them to the recipient's EPG.

Although described in the context of sending a communication or message to another mobile phone, it will be appreciated that the functionality described herein is equally applicable to other devices such as a PVR 30, included with or operative on a television 32, a computer 28, such as a laptop or a media center CPU, a home network or other devices.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A portable communication device comprising:
an electronic program guide application stored in a memory on the portable communication device, wherein when the electronic program guide application is executed, the electronic program guide application causes the portable communication device to access an electronic program guide including at least one broadcast program available for viewing on the portable communication device and electronic program guide metadata representative of the at least one broadcast program; and
an electronic program guide sharing application stored in the memory on the portable communication device, wherein when the electronic program guide sharing application is executed, the electronic program guide sharing application causes the portable communication device to embed electronic program guide metadata representative of the at least one broadcast program into a communication for transmission to a remote device.

2. The portable communication device of claim 1, wherein the electronic program guide application is operable to receive input from a user to initiate the electronic program guide sharing application.

3. The portable communication device of claim 1, wherein the electronic program guide application is operable to prompt a user to share a broadcast program.

4. The portable communication device of claim 1, further comprising a messaging application operable to send communications having embedded electronic program guide metadata to the remote device and receive communications from the remote device.

5. The portable communication device of claim 4, wherein the communication includes at least one of a SMS message, MMS message, and/or a text, audio or video message containing user input.

6. The portable communication device of claim 4, wherein the electronic program guide sharing application causes the portable communication device to retrieve embedded electronic program guide metadata from the communication transmitted by the remote device.

7. The portable communication device of claim 6, wherein the electronic program guide application causes the portable communication device to fetch the broadcast program represented by the embedded electronic program guide metadata.

8. The portable communication device of claim 6, wherein the electronic program guide application causes the portable communication device to add electronic program guide information to the electronic program guide based on the electronic program guide metadata embedded in the received communication.

9. The portable communication device of claim 1, wherein the communication further comprises text, video and/or audio content.

10. A method of sharing program guide information implemented with a portable communication device, the method comprising:
receiving electronic program guide information, the electronic program guide information being representative of at least one program available for viewing on the portable communication device and electronic program guide metadata representative of the at least one program;
embedding the electronic program guide metadata into a communication; and
transmitting the communication to a remote device.

11. The method of claim 10, further comprising prompting a user to share the at least one broadcast program with a third party.

12. The method of claim 10, further comprising receiving user input indicative of a desire to share a program.

13. The method of claim 10, wherein the communication comprises text, video and/or audio input from a user.

14. A method of sharing program guide information implemented with a portable communication device, the method comprising:
receiving a communication from a remote device, the communication including embedded electronic program guide metadata representative of a broadcast program;
accessing the embedded electronic program guide metadata in the communication;
adding the broadcast program to an electronic program guide associated with the portable communication device via the embedded electronic program guide metadata.

15. The method of claim 14, further comprising prompting a user to accept or reject the embedded metadata.

16. The method of claim 14, wherein the communication includes a text message, SMS message, MMS message, or email transmission.

17. The method of claim 16, wherein the communication includes textual, video and/or audio input from another user.

18. The method of claim 17, further comprising fetching a broadcast program represented by the embedded electronic program guide metadata.

19. The method of claim 14, further comprising:
transmitting a return message to the remote device, wherein the return message includes comments about the broadcast program and/or acceptance or denial of the broadcast program in the electronic program guide.
